(19) United States
(12) Patent Application Publication
(10) Pub. No.: US 2002/0170060 A1
(43) Pub. Date: Nov. 14, 2002

(54) Methods and apparatus for transmitting portal content over multiple transmission regions

(76) Inventor: Julie F. Lyman, Bothell, WA (US)

Correspondence Address: HARNESS, DICKEY & PIERCE, P.L.C., P.O. BOX 828, BLOOMFIELD HILLS, MI, 48303, US

(21) Appl. No.: 09/851,369

(22) Filed: May 8, 2001

(51) Int. Cl. H04N 7/20; H04N 7/18

(52) U.S. Cl. 725/73; 725/76; 725/63; 725/64; 725/67; 725/68

(57) ABSTRACT

A method for providing region-specific data content to a plurality of platforms traveling in a plurality of satellite coverage regions as the platforms leave one region and enter another region. Each platform includes a mobile communications system configured for bidirectional communication with a ground segment via satellite link. Within each of the coverage regions, data content selected for the region is multicast to platforms via an associated ground station and satellite. As a platform leaves one of the coverage regions and enters another of the coverage regions, the mobile communications system on the entering platform is configured, via the ground station associated with the coverage region being left, to receive the multicast in the coverage region being entered. This method allows a mobile platform provider automatically to provide its passengers with current and location-specific information, with minimal interruption from satellite handover, as a platform travels from one satellite coverage region to another.

### CROSS-REFERENCE TO RELATED APPLICATIONS

This application is a continuation-in-part of U.S. patent application Ser. No. 09/639,912 filed on Aug. 16, 2000, presently pending, the disclosure of which is incorporated herein by reference.

### FIELD OF THE INVENTION

The present invention relates to transmitting data content over networked computer systems and more particularly to transmitting data content via satellite to mobile platforms traveling in more than one satellite coverage region.

### BACKGROUND OF THE INVENTION

Broadband data and video services have not been widely available to users on mobile platforms such as aircraft, boats, trains, and automobiles. Network systems have traditionally been limited in bandwidth and link capacity, making it prohibitively expensive and/or unacceptably slow to distribute such services to all passengers on a mobile platform. Certain limited services are available to provide video programming to a mobile platform. For example, one service provides either TV broadcast services from available direct broadcast signals (i.e. Echostar® and DirecTV®) or provides a custom TV broadcast signal through dedicated satellite links (i.e. Airshow®).

Limited Internet access also is currently available to a user on a mobile platform. For example, a narrow-bandwidth Internet connection is available via a standard computer telephone modem between a user's computer and the air-ground or ship-shore telephony system. Another service is anticipated to provide world-wide-web content to users on a mobile platform. The web content, however, is pre-stored on a server located on the mobile platform and is updated while the platform is in an inactive mode, for example, when an aircraft is parked at an airport gate or when a ship is docked at a port.

A system described in co-pending U.S. patent application Ser. No. 09/639,912 provides bidirectional data services and live television programming to mobile platforms. Data content is transferred via satellite communications link between a ground-based control segment and a mobile RF transceiver system carried on each mobile platform. Each user on each mobile platform is able, using a laptop, personal digital assistant (PDA) or other computing device, to interface with an on-board server. Each user can independently request and obtain, for example, Internet access, company intranet access and live television programming. Real-time programming is supplied, for example, by Direct Broadcast Satellite (DBS) service providers such as Echostar®, Digital Video Broadcast (DVB®) and DirecTV®, or by sending packetized video over the Fixed Satellite Services (FSS) system. The system also provides the user with video and audio content stored on the server that can be refreshed periodically during transit.

The above system provides data content that is implemented, for example, as a set of HTML pages housed on the on-board server. The content is kept fresh by periodic updates from at least one ground-based server and is available to the user via a user portal. A mobile platform provider such as an airline can customize portal content to provide information useful to passengers, for example, information relating to a passenger's destination and/or airline flight schedules. A passenger traveling by aircraft of course would expect such information to be kept up-to-date and geographically relevant as the aircraft travels from one destination to another.

As a platform travels from one satellite coverage region to another, communication linkage between the platform and the ground segment is handed over from one satellite to another. During the handover process, communication links are dropped between the platform and ground-based servers in the region the platform is leaving, and provision of data content from the ground to the platform is interrupted. It would be desirable, as the platform enters a new coverage region and ground links are again established, to continue to provide the passenger with video and data content with minimal interruption. It also would be desirable to adapt content as appropriate to the region, for example, to provide content in a language spoken in the new region. Additionally, passengers, for example, on an aircraft crossing more than one satellite coverage region would appreciate on-board access to airline-specific information that is kept fresh and relevant to passenger scheduling and destinations.

### SUMMARY OF THE INVENTION

In one preferred embodiment, this invention is directed to a method for providing data content to a plurality of platforms traveling in a plurality of satellite coverage regions. Each platform includes a mobile communications system configured for bidirectional communication with a ground segment via satellite link. Within each of the coverage regions, data content selected for the region is multicast to platforms via an associated ground station and satellite. As a platform leaves one of the coverage regions and enters another of the coverage regions, the mobile communications system on the entering platform is configured to receive the multicast in the coverage region being entered. The foregoing step of configuring the mobile communications system is performed via the ground station associated with the coverage region being left.

The above method allows a mobile platform provider automatically to provide its passengers with current and location-specific information as a platform travels from one satellite coverage region to another. The method also allows a mobile platform provider to control data content and video programming continuity over more than one satellite coverage region and to change data and video content automatically as a platform leaves one satellite coverage region and enters another.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram illustrating a system for providing bidirectional data services and live television programming to mobile platforms;

FIG. 2 is a simplified block diagram of a mobile system carried on each mobile platform;

FIG. 3 is a simplified block diagram illustrating a portal multicast within a single region;

FIG. 4 is a simplified block diagram illustrating a rebroadcast multicast within a single region;

FIG. 5 is a simplified block diagram illustrating portal and/or rebroadcast multicasts in three coverage regions; and

FIG. 6 is a simplified block diagram illustrating content refresh for a platform traveling in three coverage regions.

### DETAILED DESCRIPTION OF THE PREFERRED EMBODIMENTS

The following description of the preferred embodiments is merely exemplary in nature and is in no way intended to limit the invention, its application, or uses.

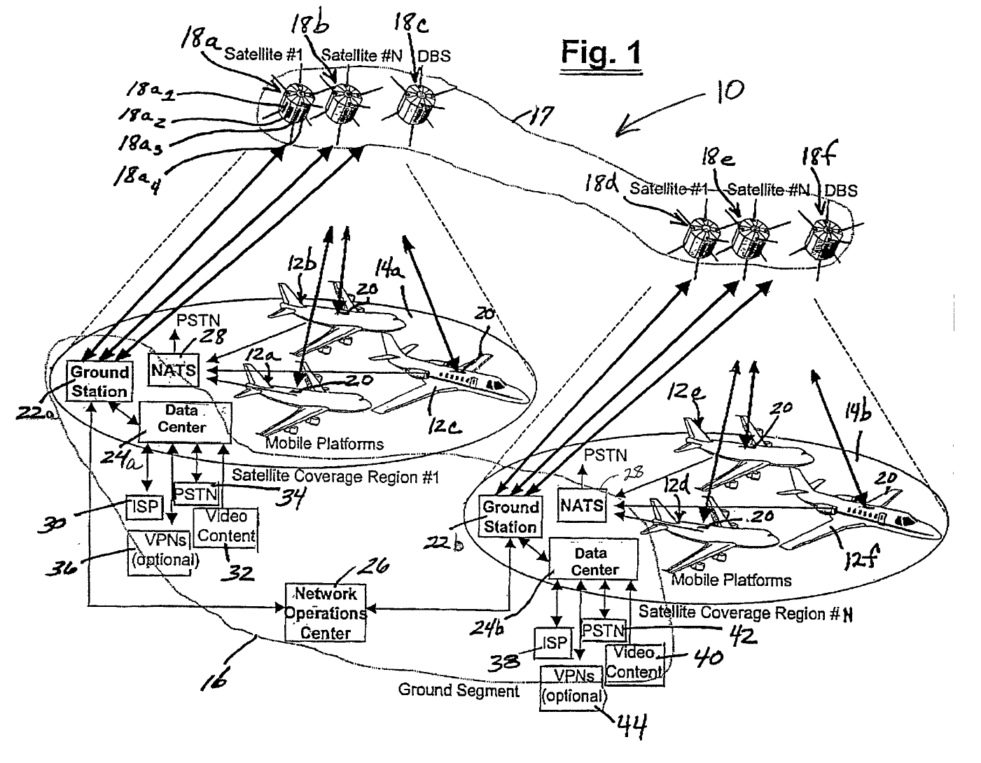

A system in accordance with a preferred embodiment of the present invention is generally indicated in FIG. 1 by reference numeral 10, for providing bidirectional data services and live television programming to mobile platforms 12a-12f in one or more coverage regions 14a and 14b. The system 10 includes a ground-based segment 16, a plurality of orbiting satellites 18a-18f, and a mobile communications system 20 disposed on each moving platform 12. Each mobile system 20 is in bidirectional communication with at least one of the satellites 18.

As described below, the present invention in one embodiment is directed to a system for providing data content to a plurality of platforms traveling in a plurality of satellite coverage regions 14. The moving platforms could include aircraft, cruise ships or any other moving vehicle. Thus the illustration of the moving platforms 12 as aircraft herein, and the reference to the mobile platforms as aircraft throughout the following description, should not be construed as limiting the applicability of the system 10 and/or the present invention to only aircraft.

The system 10 may include any number of satellites 18 in each coverage region 14a and 14b needed to provide coverage for each region. Satellites 18a, 18b, 18d and 18e are preferably Ku- or Ka-band satellites. Satellites 18c and 18f are Broadcast Satellite Services (BSS) satellites. Each of the satellites 18 is further located in a geostationary orbit (GSO) or a non-geostationary orbit (NGSO). Examples of NGSO orbits include low Earth orbit (LEO), medium Earth orbit (MEO) and highly elliptical orbit (HEO). Each of the satellites 18 includes at least one radio frequency (RF) transponder. Satellite 18a, for example, is illustrated as having four transponders 18a₁-18a₄. Each other satellite 18 illustrated could have a greater or lesser number of RF transponders for handling the anticipated number of mobile platforms 12 operating in the associated satellite coverage area 14. The transponders provide “bent-pipe” communications between the aircraft 12 and the ground segment 16.

The transponders preferably include Ku-band transponders in the frequency band designated by the Federal Communications Commission (FCC) and the International Telecommunications Union (ITU) for Fixed Satellite Services (FSS) or BSS satellites. Also, different types of transponders may be used (i.e., each satellite 18 need not include a plurality of identical types of transponders) and each transponder may operate at a different frequency. Each of the transponders 18a₁18a₄ further includes wide geographic coverage, high effective isotropic radiated power (EIRP) and high gain/noise temperature (G/T).

The ground segment 16 includes one or more ground stations 22, e.g. stations 22a and 22b as shown in FIG. 1, in bidirectional communication with at least one of the satellites 18. Each ground station 22 also is in bidirectional communication with an associated content center or data center 24. Each ground station 22 also is in bi-directional communication with a network operations center (NOC) 26 via a terrestrial ground link or other suitable communication link. An optional air telephone system 28, e.g. the National Air Telephone System (NATS), may provide a return link from a mobile platform 12 alternative to that provided by the satellites 18. Each ground station 22 may be located anywhere within its associated coverage region 14.

Referring to coverage area 14a, the ground station 22a includes an antenna and associated antenna control electronics for transmitting data content to the satellites 18a and 18b. The antenna of the ground station 22a may also be used to receive data content transponded by the transponders 18a₁-18a₄ originating from each mobile system 20 of each aircraft 12 within the coverage region 14a.

The data center 24 in each coverage region 14 is in communication with a variety of external data content providers and controls the transmission of video and data information received by it to the associated ground station 22. The data center 24a is in contact, for example, with an Internet service provider (ISP) 30, a video content source 32 and a public switched telephone network (PSTN) 34. Optionally, the data center 24a can also communicate with one or more virtual private networks (VPNs) 36. The ISP 30 provides Internet access to each of the occupants of each aircraft 12a-12c. The video content source 32 provides live television programming, for example, Cable News Network® (CNN) and ESPN®. The NOC 26 performs traditional network management. The data center 24b associated with the ground station 22b in the coverage region 14b is in communication with an ISP 38, a video content provider 40, a PSTN 42, and a VPN 44. An air telephone system 28 also may be included as an alternative to the satellite return link.

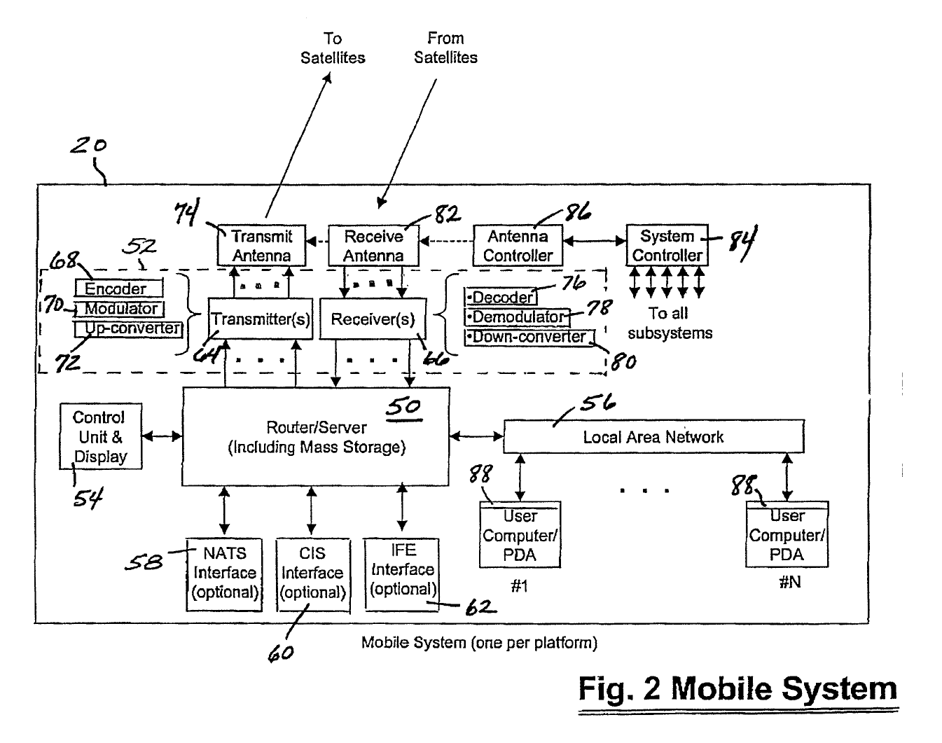

The mobile system 20 disposed on each aircraft 12 is shown in FIG. 2 and shall be discussed with reference to the aircraft 12a. The mobile system 20 includes a data content management system in the form of a router/server 50. The router/server 50 is in communication with a communications subsystem 52, a control unit and display system 54, and a distribution system in the form of a local area network (LAN) 56. Optionally, the router/server 50 can also be configured for operation in connection with a National Air Telephone System (NATS) 58, a crew information services system 60 and/or an in-flight entertainment system (IFE) 62.

The communications subsystem 52 includes a transmitter subsystem 64 and a receiver subsystem 66. The transmitter subsystem 64 includes an encoder 68, a modulator 70 and an up-converter 72 for encoding, modulating, and up-converting data content signals from the router/server 50 to a transmit antenna 74. The receiver subsystem 66 includes a decoder 76, a demodulator 78 and a down-converter 80 for decoding, demodulating and down-converting signals received by a receive antenna 82 into baseband video and audio signals, as well as data signals. While only one receiver subsystem 66 is shown, a plurality of receiver subsystems 66, and a corresponding plurality of components 76-80, typically are included to enable simultaneous reception of RF signals from a plurality of RF transponders.

The signals received by the receiver subsystem 66 are input to the router/server 50. A system controller 84 is used to control all subsystems of the mobile system 20. The system controller 84 provides signals to an antenna controller 86 which is used to electronically steer the receive antenna 82 to maintain the receive antenna 82 pointed at a particular one of the satellites 18, which will hereinafter be referred to as the “target” satellite. The transmit antenna 74 is slaved to the receive antenna 82 such that it also tracks the target satellite 18. It will be appreciated that some types of mobile antennas may transmit and receive from the same aperture. In such case the transmit antenna 74 and the receive antenna 82 are combined into a single antenna.

The local area network (LAN) 56 is used to interface the router/server 50 to a plurality of access stations 88 associated with each seat location on board the aircraft 12a. Each access station 88 can be used to provide direct two-way communication between the router/server 50 and a user's laptop computer, personal digital assistant (PDA) or other personal computing device of the user. The access stations 88 could also each include a seat-back-mounted computer/display. The LAN 56 enables bidirectional communication of data between the user's computing device and the router/server 50 such that each user is able to request a desired channel of television programming, access a desired website, access his/her email, or perform a wide variety of other tasks independently of the other users on board the aircraft 12a. The receive and transmit antennas 82 and 74, respectively, may include any form of steerable antenna, including electronically scanned, phased array antennas.

Referring further to FIG. 1, in the operation of the system 10, data content is formatted into Internet Protocol (IP) packets before being transmitted either by a ground station 22 (hereinafter referred to as a “forward link” transmission) or from the transmit antenna 74 of each mobile system 20. IP packet multiplexing also is employed such that data content can be provided simultaneously to each of the aircraft 12 operating, for example, within the coverage region 14a using unicast, multicast and broadcast transmissions. The IP packets received by each of the transponders 18a₁-18a₄ are broadcast by the transponders to each aircraft 12 operating within the coverage region 14a.

Depending on the geographic size of a coverage region and the mobile platform traffic anticipated within the region, a single satellite may be sufficient to provide coverage for the entire region. A single satellite is presently capable of covering the continental United States. Other coverage regions besides the continental United States include Europe, South/Central America, East Asia, Middle East, North Atlantic, etc. It is anticipated that in a service region larger than the continental United States, a plurality of satellites 18 may be used to provide complete coverage of the service region.

The receive antenna 82 and transmit antenna 74 are each disposed on the top of the fuselage of their associated aircraft 12. The receive antenna 82 of each aircraft 12 receives the entire RF transmission of encoded RF signals representing the IP data content packets from at least one of the transponders 18a₁-18a₄. If more than one receiver 66 is incorporated, then one will be designated for use with a particular transponder 18a₁-18a₄ carried by the target satellite 18 to which it is pointed. The receiver 66 decodes, demodulates and downconverts the encoded RF signals to produce video and audio signals, as well as data signals, that are input to the router/server 50.

As further described below, the router/server 50 operates to filter off and drop any data content not intended for users on the aircraft 12 and then forwards the remaining data content via the LAN 56 to the appropriate access stations 88. In this manner, each user receives only that portion of the programming or other information previously requested by the user. Accordingly, each user is free to request and receive desired channels of programming, access email, access the Internet and perform other data transfer operations independently of all other users on the aircraft 12a.

Rebroadcast television or customized video services are received and processed in the following manner. Referring for example to the coverage area 14a, rebroadcast television or customized video content is obtained from the video content source 32 and transmitted via the ground station 22a to the FSS satellites 18a and 18b. The video content is encoded for transmission by the data center 24a before being broadcast by the ground station 22a. Some customization of the rebroadcast content may occur on the router/server 50 (FIG. 2) of the mobile system 20 or in the data center 24a to tailor advertisements and other information content to a particular market or interest of the users on the aircraft 12.

The bulk of data content provided to the users on each aircraft 12 is provided by using a portal content. This content is implemented as a set of HTML pages housed on the router/server 50 of each mobile system 20. The content is kept fresh by periodic updates from a ground-based server located in data center 24a, and in accordance with a scheduling function controlled by the NOC 26 of the ground segment 16. The router/server 50 may be configured to accept user log-on information and to keep track of user and network accounting information to support a billing system under control of the NOC 26.

The system 10 also provides direct Internet connectivity via satellite links, for example, when a user on board an aircraft 12 desires to obtain data content that is not cached on the on-board router/server 50, or as an avenue for content sources to provide fresh content for the portals. Refreshing of the cached content of the portal may be accomplished, for example, by in-flight, periodic “pushed” cache refresh over the satellite links.

Referring further to FIGS. 1 and 2, a transmission of data content from the aircraft 12a to the ground station 22a will be described. This transmission is termed a “return link” transmission. The antenna controller 86 causes the transmit antenna 74 to maintain the antenna beam thereof pointed at the target satellite 18a. The channels used for communication from each mobile system 20 back to a ground station 22 represent point-to-point links that are individually assigned and dynamically managed by the NOC 26 of the ground segment 16. When the system 10 is to accommodate several hundred or more aircraft, multiple aircraft are assigned to each transponder carried by a given satellite 18.

The receive antenna 82 may implement a closed-loop tracking system for pointing the antenna beam and for adjusting the polarization of the antennas based on receive signal amplitude. The transmit antenna 74 is preferably slaved to the point direction and polarization of the receive antenna 82. Alternatively, an open-loop tracking method may be used with the pointing direction and polarization determined by knowledge of mobile platform position and attitude using an on-board inertial reference unit (IRU) and knowledge of the location of the satellites 18.

Encoded RF signals are transmitted from the transmit antenna 74 of the mobile system 20 of a given aircraft 12 to an assigned one of the transponders 18a₁-18a₄, and transponded by the designated transponder to the ground station 22. The ground station 22 communicates with the data center 24 to determine and provide the data being requested by the user (e.g. content from the world-wide web, email or information from the user's VPN).

The aperture size of a receive antenna 82 typically is smaller than that of conventional “very small aperture terminal” (VSAT) antennas. Accordingly, the beam from the receive antenna 82 might encompass adjacent satellites along the geo-synchronous arc, resulting in interference being received by a particular mobile system 20 from satellites other than the target satellite. Thus the system 10 uses a lower than normal forward link data rate to overcome such interference. For example, the system 10 operates at a forward link data rate of about 5 Mbps per transponder, using a typical FSS Ku-band transponder (e.g. Telstar-6) and an antenna having an active aperture of about 17 inches by 24 inches (43.18 cm by 60.96 cm). For comparison purposes, a typical Ku-band transponder usually operates at a data rate of approximately 30 Mbps using conventional VSAT antennas.

Portal content can be multicast by a ground station 22 over a single coverage region 14 as shown in FIG. 3. Each of the aircraft 12 in the region 14a has a receiver 66 (shown in FIG. 2) tuned to a single portal content transponder 18a₁. Data content is multicast as IP packets from the ground station 22 (not shown in FIG. 3) via the transponder 18a₁ to a “generic” platform portal. That is, the packets are formatted for reception by every aircraft 12 utilizing the system 10 in the region 14a. Each of the aircraft 12 in the region 14a thus receives the entire multicast stream.

Each IP packet is also formatted to allow the router/server 50 on each aircraft 12 to distinguish whether the packet is to be delivered on board the aircraft 12. If the packet is not to be delivered on board, the router/server 50 drops the packet. Otherwise the router/server 50 accepts and routes the packet via the LAN 56 to the appropriate address(es), e.g. to one or more user access stations 88.

As previously described, the system 10 allows portal content to be customized for mobile platforms 12 traveling within a given coverage region 14. Referring again to FIG. 3, for example, where aircraft 12a-d are provided by an airline company A and aircraft 12e-j are provided by an airline company B, a data center 24 (not shown in FIG. 3) associated with the coverage region 14a can customize data content to relate respectively to airlines A and B. The data content for both airlines is encoded into packets and multicast via the transponder 18a₁ to the aircraft 12a-j. Each of the aircraft 12a-d drops all packets except those to be delivered to airline A aircraft, and each of the aircraft 12e-j drops all packets except those to be delivered to airline B aircraft. The router/server 50 on board the aircraft 12k, for example, accepts and forwards the airline B packets to the LAN 56 (shown in FIG. 2) for distribution to the appropriate user stations 88.

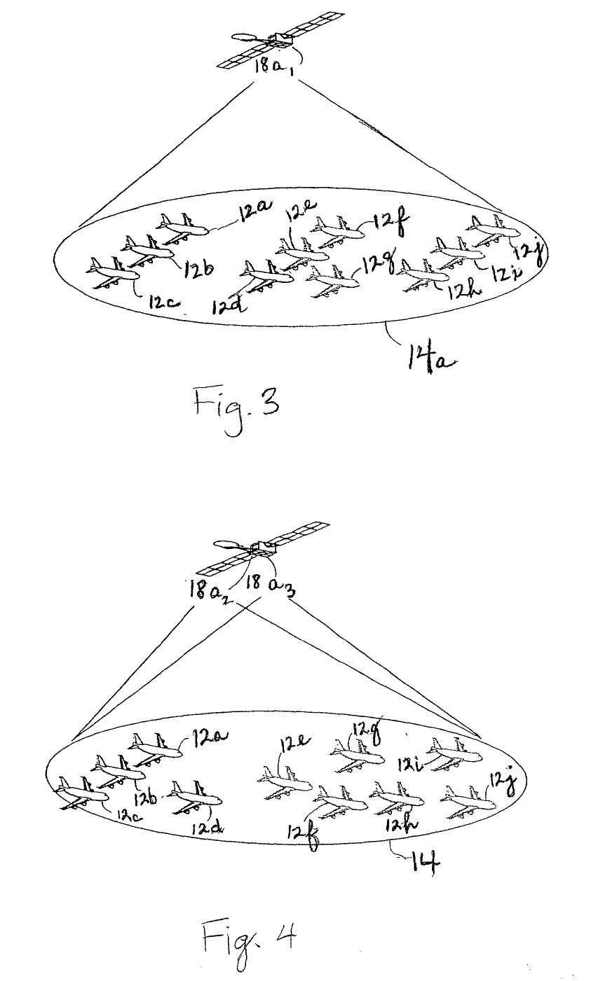

Rebroadcast content also can be multicast by a ground station 22 over a single coverage region 14 as shown, for example, in FIG. 4. As previously described, the ground station 22 (not shown in FIG. 4) multicasts encoded video content to the transponders 18a₂ and 18a₃ which transmit the content to aircraft 12a-j. Each video channel is multicast on only one of the transponders 18a2 and 18a₃, so there is no duplication of multicast content. Receivers 66 on each aircraft 12a-j are tuned to receive the video content from both of the transponders 18a₂ and 18a₃. The router/server 50 on each aircraft 12a-j drops those channels received from the transponders 18a₂ and 18a₃ but not intended for use on the aircraft. Thus, for example, the router/server 50 on the aircraft 12a accepts and serves to the on-board LAN 56 only channel content requested by one or more users of aircraft 12a access stations 88. Rebroadcast data content is transmitted to the aircraft 12 in available bandwidth. That is, transmission rates are adjusted as available bandwidth fluctuates, so that transmission continuity may be maintained.

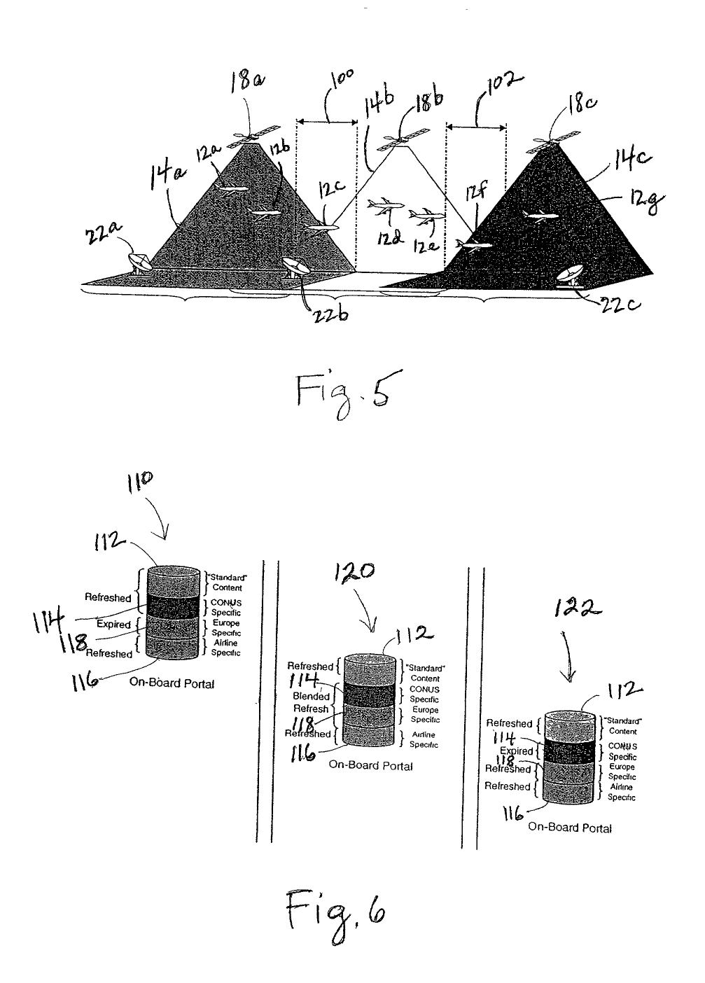

An embodiment of a method for providing data content to a plurality of platforms 12 traveling in a plurality of satellite coverage regions 14 shall now be described with reference to FIG. 5. Aircraft 12a-g travel in coverage regions 14a-c covered respectively by satellites 18a-18c. For example, the coverage region 14a includes the continental United States, the region 14b includes the North Atlantic Ocean, and the region 14c includes Europe. The coverage regions 14a and 14b overlap each other in an overlap region 100. A ground station 22a serves the continental United States region 14a. A ground station 22b located in the overlap region 100 serves the North Atlantic region 14b. The coverage regions 14b and 14c overlap each other in an overlap region 102, and a ground station 22c serves the European region 14c. For each of the coverage regions 14a-c, an associated data center 24 (not shown in FIG. 5) in communication with its associated ground station 22 selects and encodes data content as IP packets for transmission to platforms 12 traveling in its coverage region. The encoded data contents for regions 14a, 14b and 14c are transmitted respectively to the ground stations 22a, 22b and 22c.

The ground station 22a multicasts, via the satellite 18a, data content selected for the continental United States region 14a. As further described below, each router/server 50 aboard the aircraft 12 has stored an IP forwarding table containing IP addresses corresponding to a regional multicast. Each aircraft 12 receives a multicast data stream according to the contents of its forwarding table. For example, the aircraft 12a-b router/server forwarding tables contain IP addresses corresponding to the ground station 22a multicast. The aircraft 12a-b receive the entire United States region 14a data content, and each aircraft 12a-b drops packets not intended for on-board delivery as described above with reference to FIGS. 3 and 4.

The ground station 22b multicasts, via the satellite 18b, data content selected for the North Atlantic region 14b. The router/server 50 forwarding table on each of the aircraft 12d-e contains IP addresses corresponding to the ground station 22b multicast. The ground station 22b multicast is received in its entirety by the aircraft 12d-e, each of which drops packets not intended for on-board delivery. In the same way, the ground station 22c multicasts, via the satellite 18c, data content selected for the European region 14c and addressed to IP addresses in the router/server 50 forwarding table on board the aircraft 12g. The regional multicasts are transmitted periodically as further described below.

As a platform 12 leaves a coverage region 14 to enter another coverage region 14, the ground stations 22 associated with the region being left and the region being entered perform satellite hand-off or handover procedures to transfer satellite link communications from one satellite 18 to another. In the present embodiment, at satellite handover, the ground station 22 associated with the region 14 being left by the platform 12 transmits, via satellite link, changes to the IP forwarding table aboard the platform 12. The forwarding table is changed to authorize, or configure, the platform mobile communications system 20 to receive data content multicasts being transmitted in the region 14 being entered by the platform 12.

For example, referring to FIG. 5, as the aircraft 12c travels in the overlap region 100, the ground station 22a transmits changes to the forwarding table of the mobile system 20 on board the aircraft 12c. The forwarding table changes allow the aircraft 12c to receive the North Atlantic region 14b data content multicast via the satellite 18b. Similarly, as the aircraft 12f travels in the overlap region 102, its forwarding table is changed by the ground station 22b to allow the aircraft 12f to receive the European 14c multicast.

Data content can be refreshed on board a platform 12 traveling over a plurality of regions 14, e.g. an aircraft 12 traveling from the continental United States (CONUS) to Europe, as shown in FIG. 6. Referring to FIGS. 5 and 6, data content indicated by reference number 110 is received by the aircraft 12 as it travels through the CONUS region 14a. The ground station 22a transmits, for example, a “standard” content 112, a CONUS-specific content 114, and an airline-specific content 116. The standard content 112 can include, for example, video entertainment and/or reading material for delivery to aircraft 12 passengers upon request via access stations 88. The CONUS-specific content 114 can relate, for example, to travel, current events, aircraft destinations and/or geographical locations in the CONUS. The standard content 112 and CONUS-specific content 114 can be made available, for example, to all aircraft utilizing the system 10 in the CONUS region 14a. Airline-specific content 116 can be multicast to aircraft 12 of a particular airline, as previously described with reference to FIG. 3. The airline-specific content 116 can pertain to topics such as scheduling, ticketing and airline facilities. The standard content 112, CONUS-specific content 114 and airline-specific content 116 are refreshed periodically by the ground station 22a, for as long as the aircraft 12 travels thorough the CONUS region 14a until satellite handover occurs. The user portals on the aircraft 12 are also configured to receive a Europe-specific content 118 relating, for example, to travel, current events, aircraft destinations and/or geographical locations in Europe. The Europe-specific content 118, although refreshed during travel over Europe as further described below, is allowed to expire, i.e. is not multicast, to the aircraft 12 as it travels over the CONUS region 14a.

As the aircraft 12 leaves the CONUS and enters the North Atlantic, its IP forwarding table is changed by the ground station 22a as satellite handover occurs in the overlap region 100. A portal refresh by the ground station 22b provides data content indicated by reference number 120, which is available to passengers on the aircraft 12 while traveling over the North Atlantic region 14b. The standard content 112 and airline-specific content 116 continue to be refreshed periodically on aircraft 12 traveling in the North Atlantic region 14b. Portions of the CONUS-specific content 114 and the Europe-specific content 118 are refreshed by the ground station 22b while other portions of contents 114 and 118 are allowed to expire. Thus, transitional geographically related content can be provided to passengers crossing the Atlantic.

As the aircraft 12 leaves the North Atlantic and enters Europe, the ground station 22b changes the IP forwarding table of the aircraft 12 at satellite handoff in the overlap region 102. A portal refresh from the ground station 22c then provides data content 122 available to the aircraft 12 while traveling through the European region 14c. The standard content 112 and airline-specific content 116 continue to be refreshed periodically by the ground station 22c. The CONUS-specific content 114 is allowed to expire, while the Europe-specific content 118 is refreshed.

The foregoing description of portal content refresh is exemplary only. It can be appreciated that many different categories of content can be provided to users on moving platforms such as the aircraft 12, and that content within a category can change from coverage region to coverage region. For example, the standard content 112 could be provided in different languages and/or include different video features in different coverage regions. Multicasts via a plurality of ground stations 22 over a plurality of coverage regions 14 can be coordinated and scheduled by the NOC 26, in accordance with the scheduling function controlled by the NOC 26 as previously described.

As previously described, the system 10 can operate at a forward link data rate of about 5 Mbps per transponder, using a typical FSS Ku-band transponder. The present embodiment also is implemented, for each coverage region 14, at a data rate of about 5 Mbps on forward link transmission of portal data content to a single transponder of each associated satellite 18. For transmission of rebroadcast video content to associated transponders in each region, where, for example, one high-definition channel is operated at about 2.0 Mbps, four low definition channels are operated at about 2.8 Mbps, and six audio channels are operated at about 0.1 Mbps, the present embodiment can be implemented for rebroadcast data at a total bandwidth of about 4.9 Mbps. During satellite handover between two coverage regions, time between the end of one regional multicast and the beginning of the next multicast is estimated to be up to about ten seconds.

The above described system and method for transmitting portal content allow data and video content for user portals to be customized to relate to geographic and cultural characteristics of different satellite coverage regions. The customized content can be provided to users on board platforms traveling from one satellite coverage region to another, with minimal interruption from satellite handover.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for providing data content to a plurality of platforms traveling in a plurality of satellite coverage regions, each platform including a mobile communications system configured for bidirectional communication with a ground segment via satellite link, said method comprising the steps of:
within each of the coverage regions, multicasting data content selected for the region to platforms via an associated ground station and satellite; and
as a platform leaves one of the coverage regions and enters another of the coverage regions, configuring the mobile communications system on the entering platform to receive the multicast in the coverage region being entered, said step being performed via the ground station associated with the coverage region being left.

2. A method in accordance with claim 1 further comprising the step of customizing data content for a regional multicast to relate to at least one of a platform provider, a geographic location and a platform destination.

3. A method in accordance with claim 1 wherein said step of multicasting data content comprises the step of multicasting video content.

4. A method in accordance with claim 1 wherein said step of multicasting data content is performed within the plurality of coverage regions using a scheduling function.

5. A method in accordance with claim 1 further comprising the step of configuring the mobile communications system to drop data content directed to platforms other than those provided by the provider of the entering platform.

6. A method in accordance with claim 1 further comprising the step of configuring the mobile communications system to accept at least a portion of the multicast data content for delivery to a user on the entering platform.

7. A method in accordance with claim 1 wherein said step of configuring the mobile communications system on the entering platform comprises the step of transmitting changes to a forwarding table of the mobile communications system.

8. A method in accordance with claim 7 wherein said step of transmitting changes to a forwarding table is performed at satellite hand-off.

9. A method in accordance with claim 1 further comprising the step of varying the data content multicasts according to coverage region.

10. A method in accordance with claim 1 wherein said step of multicasting data content comprises the step of refreshing at least a portion of data content previously received by a platform while in another coverage region.

11. A method in accordance with claim 1 wherein said step of multicasting data content comprises the step of allowing at least a portion of data content previously received by a platform while in another coverage region to expire.

12. A system for transmitting data content to a plurality of platforms traveling in a plurality of satellite coverage regions, said data content system comprising:
on each of the platforms, a mobile communications system configured for bidirectional communication with a ground segment via satellite link;
for each of the coverage regions, an associated ground station and satellite configured to multicast data content to platforms in the coverage region, said associated ground station further configured to authorize, as a platform leaves the coverage region and enters another of the coverage regions, said mobile communications system of the leaving platform to receive the data content multicast in the coverage region being entered.

13. A data content transmission system in accordance with claim 12 wherein said mobile communications system on at least one of the platforms is configured to drop data content directed to platforms not provided by a provider of the at least one platform.

14. A data content transmission system in accordance with claim 12 wherein, for each of the coverage regions, said associated ground station is configured to transmit changes to a forwarding table of said mobile communications system on a platform leaving the coverage region.

15. A data content transmission system in accordance with claim 12 further comprising a network operations center configured to coordinate multicasts of data content by said ground stations in the plurality of coverage regions.

16. A data content transmission system in accordance with claim 12 further comprising, for each of the coverage regions, a data content center configured to provide multicast data content customized for the coverage region.

17. A data content transmission system in accordance with claim 12 wherein, for each of the coverage regions, said associated ground station and satellite are configured to multicast video data to users on a platform in the coverage region.

18. A method for providing data content to a platform traveling in a plurality of satellite coverage regions, the platform including a mobile communications system configured to transmit and receive data via satellite link, said method comprising the steps of:
within each of the coverage regions, multicasting, via a ground station and a satellite associated with the coverage region, data content selected for the coverage region; and
authorizing the platform mobile communications system to receive the multicast in a region into which the platform is moving, said step being performed, as the platform leaves one of the coverage regions, via the ground station associated with the coverage region being left.

19. A method in accordance with claim 18 further comprising the step of using a scheduling function to refresh the data content multicasts in each of the coverage regions.

20. A method in accordance with claim 18 wherein said step of authorizing the platform mobile communications system comprises the step of changing a forwarding table of the platform mobile communications system at satellite handover.
